(19) United States
(12) Patent Application Publication
(10) Pub. No.: US 2013/0297368 A1
(43) Pub. Date: Nov. 7, 2013

(54) UPDATING CUSTOMER RELATIONSHIP MANAGEMENT SYSTEMS THROUGH SALES PLAYBOOK ACTIVITIES

(71) Applicants: Karen P. Meyer, Nashua, NH (US); Michelle L. Lavers, Maynard, MA (US); Mark A. Walling, Bedford, MA (US); Eduard M. Kantsevich, Billerica, MA (US); Leo P. Steffens, Bedford, NH (US); John S. Gedaminski, Groton, MA (US)

(72) Inventors: Karen P. Meyer, Nashua, NH (US); Michelle L. Lavers, Maynard, MA (US); Mark A. Walling, Bedford, MA (US); Eduard M. Kantsevich, Billerica, MA (US); Leo P. Steffens, Bedford, NH (US); John S. Gedaminski, Groton, MA (US)

(73) Assignee: QVIDIAN, INC., Lowell, MA (US)

(21) Appl. No.: 13/462,504

(22) Filed: May 2, 2012

(51) Int. Cl. G06Q 10/06

(52) U.S. Cl. 705/7.26

(57) ABSTRACT

As plays, stages and other playbook elements are processed or completed in the sales playbook, fields of the customer relationship management system are updated by the playbook system according to predefined update rules. Thus, updating of the customer relationship management system is no longer done separately and manually from activities driven by the sales playbook, and the consistency of data in the two systems is improved. In turn, because the sales playbook is driven by data in the customer relationship management system, activity in the sales playbook can dynamically drive further actions in the sales playbook.

### BACKGROUND

For sophisticated sales processes, companies generally maintain computer systems that track substantial amounts of information about customers and potential customers. Such computer systems are commonly referred to as customer relationship management (CRM) systems.

Another tool that is commonly used in sophisticated sales processes is a sales playbook. A sales playbook defines a sequence of steps to be performed by a user, such as sales personnel, marketing personnel, customer support personnel and other users in an organization, when engaging a prospect. A sales playbook can be implemented on a computer, herein called a computerized sales playbook system, and includes several playbook elements, each of which includes instructions, content, and the like to be used in the step of engaging a prospect.

While some computerized sales playbook systems have access to data in a customer relationship management system, the data in the two computer systems generally are maintained through separate processes. In other words, one or more users update data in the CRM system, and separately one or more users update data in the computerized sales playbook system.

The steps of the sales process often are situational, in that they depend on the status of the prospect in the sales process. This situational nature can be expressed by a set of rules or conditions that determine, based on data about a prospect such as from a CRM system, whether a playbook, or action within a playbook, or specific content in the playbook, is provided to a user.

### SUMMARY

As plays, stages and other playbook elements are processed or completed in the sales playbook, fields of the customer relationship management system are updated by the playbook system according to predefined update rules. Thus, the customer relationship management system is no longer updated manually and separately from activities in the sales playbook, and the consistency of data in the two systems is improved. In turn, because the sales playbook is driven by data in the customer relationship management system, activity in the sales playbook can dynamically drive further actions or specific content in the sales playbook.

When a computerized sales playbook is defined, it is enabled to update the CRM system through one or more update rules. An update rule is associated with a playbook, play or stage. An update rule defines an action that updates the CRM system upon completion of, or occurrence of an event during, the playbook, play or stage. The action can be defined, for example, by a field of an object in the customer relationship management database, and a value to store in that field.

In one implementation, a user interface has a selection interface that presents available CRM fields to a user for selection. This list of fields is populated by accessing available CRM fields and their associated values through an application programming interface of the CRM system. For a playbook element, and a CRM field associated with that playbook element, the user defining the playbook, herein called a playbook manager, defines an action that will set the CRM field to a desired value when the playbook element is completed.

For example, the playbook manager may define a play called “send email,” instructing a user to send a prospect an email with particular content. Then, the playbook manager defines an update rule that is processed when the user indicates that this activity has been completed. This update rule, for example, can set a “status” CRM field for the prospect to “sent email” or other appropriate designation. Multiple CRM fields can be set or updated. Multiple update rules can be associated with a playbook, play or stage.

When the playbook is being used, the user accesses the CRM record for the prospect, and opens a playbook. The playbook then indicates what plays to execute for this prospect. When the user is directed to send this email, and does, and then indicates in the sales playbook that this play has been completed, the system accesses the CRM system to update the CRM field(s) in the manner specified by the playbook manager.

This Summary is intended to provide a brief introduction to concepts in a simplified form which are described further in the Detailed Description. This Summary is intended neither to identify any essential features of the claimed subject matter, nor to be used to limit the scope of the claimed subject matter.

### BRIEF DESCRIPTION OF THE DRAWINGS

FIG. 1 is a block diagram of a computer system that supports a computerized sales playbook system with the capability of updating a customer relationship management system.

FIG. 2 illustrates a first interface in an example implementation of the system of FIG. 1 for associating an update rule with a playbook element.

FIGS. 3A and 3B illustrate a second interface in an example implementation of the system of FIG. 1 for associating one or more update rules with a playbook element.

FIG. 4 is a flowchart describing an example implementation of a process for associating a playbook element with an update rule for updating the customer relationship management system.

FIG. 5 is a block diagram of an example implementation of the interface between the playbook engine and the CRM system.

FIG. 6 is a flowchart describing an example implementation of a process for updating the customer relationship management system.

FIG. 7 is a block diagram of a distributed, remote access computer system supporting such a computerized sales playbook system.

### DETAILED DESCRIPTION

The following section describes an example implementation of a computerized sales playbook system.

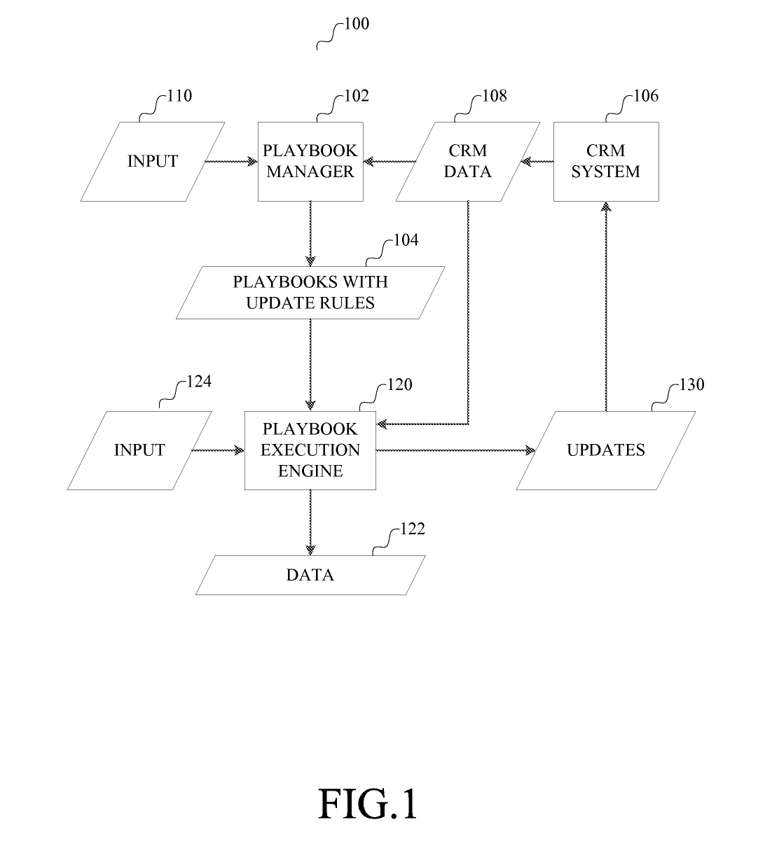

Referring to FIG. 1, a computerized sales playbook system 100 includes a playbook manager 102 through which an individual can create sales playbooks 104, by providing user input 110. The sales playbook includes a plurality of playbook elements. A playbook element includes instructions, content, and the like to be used in a step in a process of engaging a prospect. One or more of the playbook elements has an associated update rule. The sales playbooks are stored in computer readable storage. For example, playbooks, rules and the relationship between rules and playbooks can be stored as rows in a relational database. For example, one table can include rows that relate playbook elements with rules. Another table can include rows defining the playbook elements in a playbook, and the content used in each element. Another table can include rows defining elements of the rules. A variety of other implementations can be used to define playbooks, rules and their interrelationships and the invention is not limited to a specific implementation.

A customer relationship management (CRM) system 106 provides CRM data 108 to the playbook manager 102.

In the playbook manager, through user input 110, update rules can be defined and associated with a playbook element, such as a playbook, play or stage. When defining an update rule, CRM data 108 from a CRM system 106 is accessed, to allow a user to specify objects, and fields of those objects, in the CRM system which should be updated. By reading the available CRM fields at runtime, the system is able to support standard CRM fields and any custom fields that have been configured in the CRM system.

A playbook execution engine 120 receives and processes sales playbooks 104 to provide data 122 to users from the sales playbook. In particular, the engine 120 has an input for receiving a sales playbook from computer readable storage. It also has an output that presents playbook elements from the sales playbook to a user, such as by providing the data 122 to a display or to another computer. For example, data defining a sales playbook can be read from a database, and such data can be used to generate a document in a markup language, such as the eXtensible Markup Language (XML), which in turn can be sent to an application that renders the document for display.

The playbook execution engine 120 also is configured to receive input 124 from the user indicative of the user completing a playbook element. The input can come from, for example, input devices connected to a computer that supports the playbook execution engine, or from a remote computer or device used by the user. The playbook execution engine 120 also has access to CRM data 108 from the CRM system 106.

When accessing sales playbooks, various rules associated with playbook elements determine which playbooks, plays, content and other playbook elements to make available to the users. In addition, a playbook element may be configured to have one or more associated update rules.

Upon determining that a playbook element has been completed, any configured update rules for the playbook element are invoked to send updates 130 the CRM system. The completion of a playbook element can be detected, for example, in response to user input 124. As another example, completion of a playbook element can be detected automatically. For example, a playbook stage is completed when all of the plays in the stage have been completed.

For example, the playbook manager may define a play called “send email,” instructing a user to send a prospect an email with particular content. Then, the playbook manager defines an update rule that is processed when the user indicates that this activity has been completed. This update rule, for example, can set a “status” CRM field for the prospect to “sent email” or other appropriate designation. Multiple CRM fields can be set or updated. Multiple update rules can be associated with a play or stage.

When the playbook is being used, the user accesses the CRM record for the prospect, and opens a playbook. The playbook then indicates what plays to execute for this prospect. When the user is directed to send this email, and does, and then indicates in the sales playbook that this play has been completed, the system accesses the CRM system to update the CRM field(s) in the manner specified by the playbook manager.

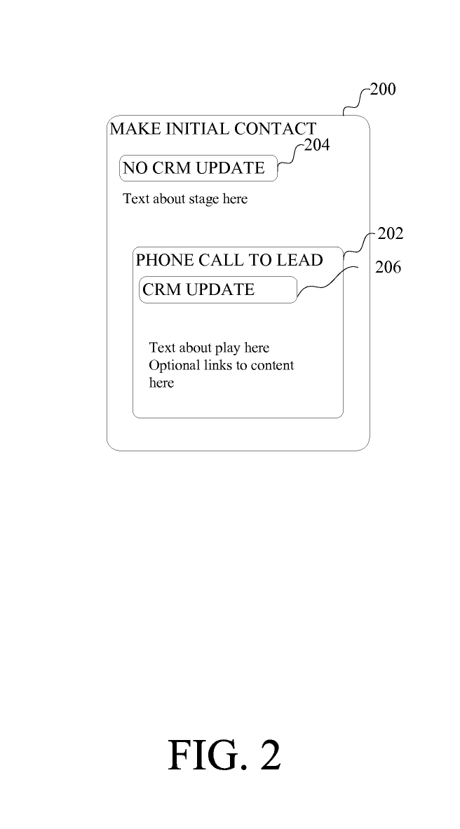

FIG. 2 illustrates a first interface in an example implementation of the system of FIG. 1 for associating an update rule with a playbook element.

A playbook element, when displayed in the playbook manager, can provide a variety of information to the user, depending on the type of the playbook element. In FIG. 2, a stage 200 is shown, which includes a play 202. Within this interface, a link 204 is provided within the stage 200, herein labeled “No CRM update,” indicating that a CRM update rule has not yet been associated with this stage. Similarly, a link 206 is provided within the play 202, also labeled “CRM update,” indicating that a CRM update rule has been associated with this play. If an update rule is associated with a play or stage, then the “No CRM Update” can be changed to “CRM Update”. In one implementation, the data indicating whether a CRM update rule is associated with a playbook element is checked to determine what text to place on the user interface element (such as link 204 or 206, or a button or other manipulable object on the user interface). When the user activates one of the links 204 or 206 through an appropriate user interface gesture, another interface is presented to allow the user to create, view, modify and/or delete one or more an update rules associated with the stage or play.

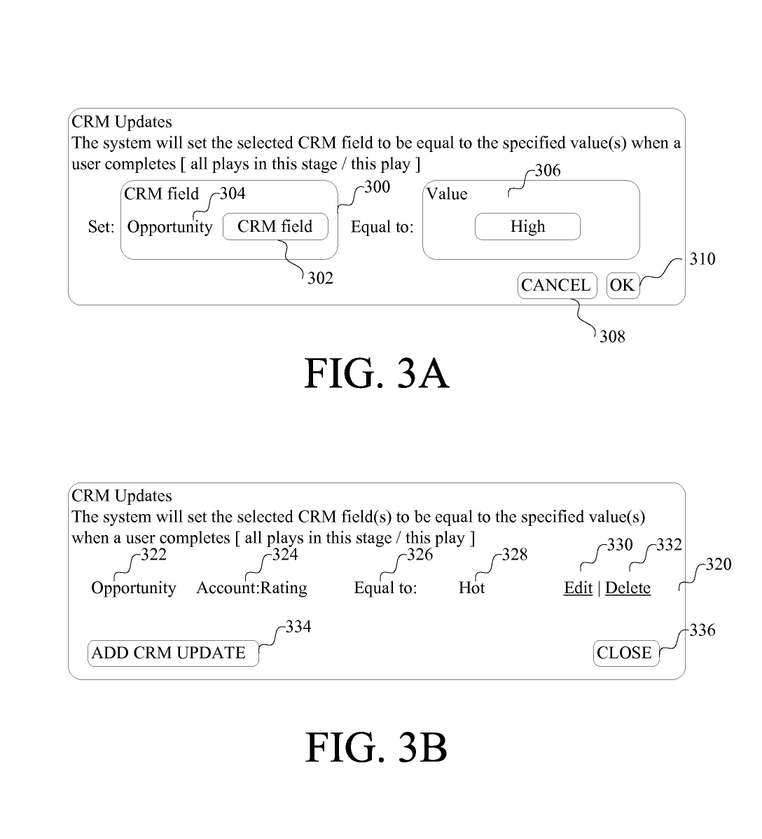

FIGS. 3A and 3B illustrate a second interface in an example implementation of the system of FIG. 1 for associating one or more update rules with a playbook element. In FIG. 3A, to create or modify an update rule, the interface presents a selection mechanism, such as a menu 300, enabling a user to select a field 302 of an object from the customer relationship management (CRM) system. The object type can be displayed as indicated at 304. This list of candidate fields can be obtained through an interface implementing an application programming interface of the CRM system, such as described below. Given a set of fields from the CRM system, a list can be presented to the user from which a selection can be made. The user also can input a value 306 to which the selected field will be updated upon completion of the playbook element. If the user selects a “Cancel” button 308, then the operation is terminated without adding or modifying an update rule; if the user selects an “OK” button 310, then the rule is added or modified. The combination of the field and value are stored as the update rule for the playbook element. The user interface can return to the display shown in FIG. 3B or in FIG. 2.

In FIG. 3B, a list 320 of the currently defined update rules is displayed. This list is generated from the rule data stored for the playbook element (whether the playbook, play or stage) which was being displayed at the time this user interface was opened. For each rule, data describing the rule is displayed. For example, data such as the CRM object name 322, CRM field name 324, rule update operation 326 and value 328 can be displayed.

Elements that can be manipulated to initiate rule operations, such as editing a rule and deleting a rule, also can be provided next to each rule, such as links 330 and 332 labeled “edit” and “delete.” A user interface element for initiating creation of a new rule also can be provided, such as by link 334 labeled “Add CRM Update.”

After selection of the “edit” element 330, the interface for editing or creating a rule (such as in FIG. 3A) is displayed. After selection of the “delete” element 332, the rule is deleted and the display 320 is updated and redisplayed without the deleted update rule. Confirmation that the user wishes the update rule to be deleted can be controlled through conventional user interface techniques. After selection of the “add” element 334, the interface for editing or creating a rule (such as in FIG. 3A) is displayed. After selection of a “close” element 336, the user interface can return to the display shown in FIG. 2.

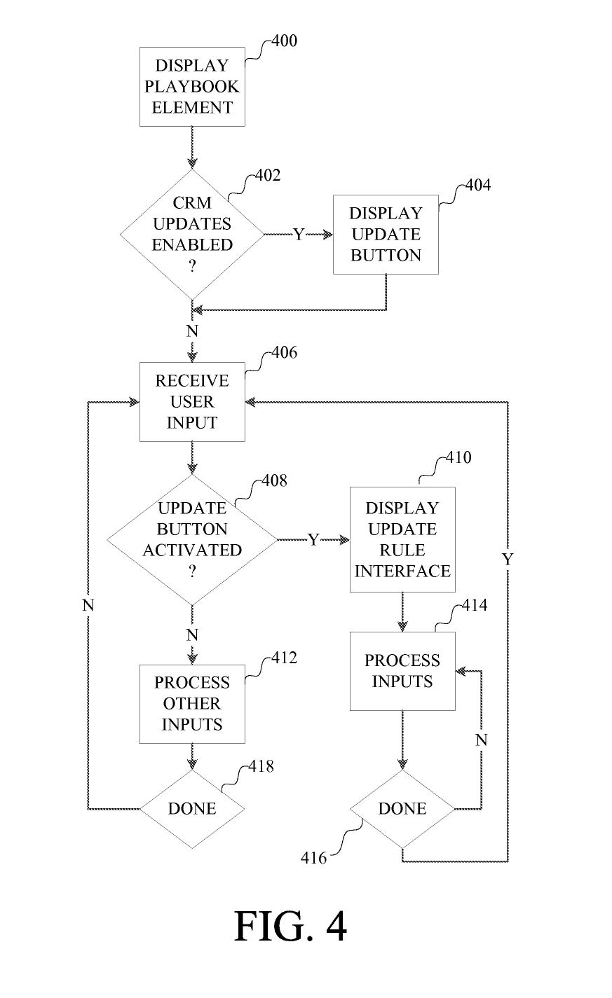

FIG. 4 is a flowchart describing an example implementation of a process for associating a playbook element with an update rule for updating the customer relationship management system.

When a playbook element, such as a play or stage, is displayed 400, the system determines whether updates of the CRM system have been enabled, as determined at 402. If CRM updates have been enabled, a button or other selector is displayed 404, which is linked to an interface that enables editing an update rule. The system receives 406 inputs from the user. If an input is an activation of the button to edit an update rule, as determined at 408, then the interface for editing an update rule is displayed 410. Otherwise, other received inputs are processed 412. If the user has chosen to enter an update rule, after the interface is displayed, further inputs for defining the update rule are processed 414. For example, given the interface shown in FIG. 3, user inputs for manipulating menus to select CRM fields and values are processed. When the user has completed defining the update rule, as determined at 416, the system returns to processing other inputs related to the playbook element (as indicated at 406). As the user continues to edit the playbook element, the playbook manager continues to process further editing inputs until editing is done, as indicated at 418.

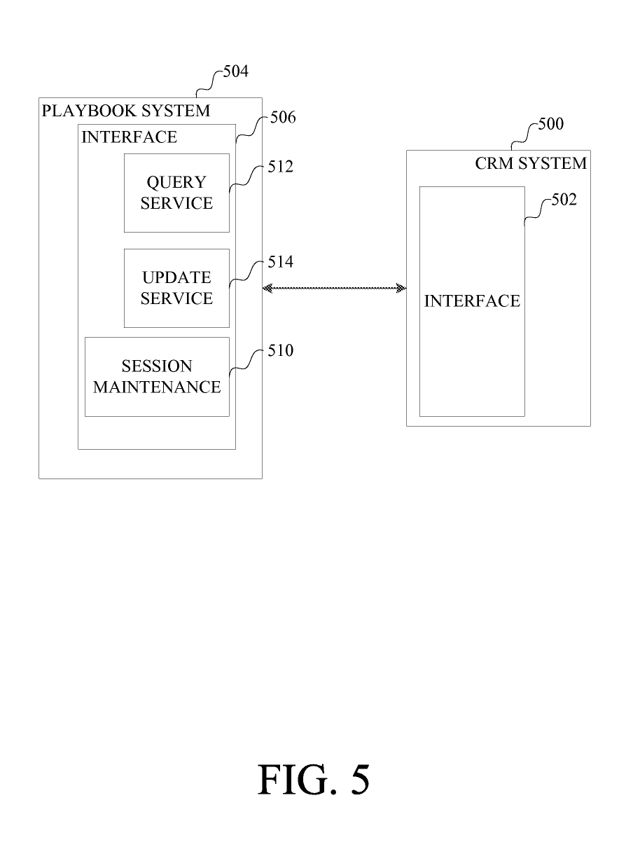

Referring now to FIG. 5, the connection between the playbook system and the customer relationship management (CRM) system will now be described in more detail.

The CRM system 500 can be implemented using a commercially available CRM system, from vendors such as Salesforce.com, Inc., Oracle Corporation, SAP, Microsoft Corporation, SugarCRM, Inc., and the like. Such a system typically has an application programming interface (API) 502, often implemented using a software development kit (SDK) through which users can connect other computer programs that interface with the CRM system. Such APIs can implement the interface in a variety of ways. For example, the interface can be such that the other computer program is a “plug in” or dynamically linked library accessed by the CRM system. As another example, the interface can be implemented in the form of a communication protocol, such that the other computer program sends messages to the CRM system in a format specified by the API, and in turn the other computer program receives messages from the CRM system in the format specified by the API.

The sales playbook system 504 includes an interface 506 that is an implementation of the CRM system API. An interface that implements an API generally implements multiple operations or services that are a subset of the full capability of the API. Details of the implementation of the interface implementing an API depend on the specification of the API for the CRM system. Three example services are shown in FIG. 5.

The first service is session maintenance 510. This service allows a user to set user credentials such as a user name and password. In turn a user can provide this information to the CRM system. Through the CRM system API, the CRM system can log into the playbook management system using that user's credentials, thus linking the user's two accounts in both the playbook management system and the CRM system.

The second service is querying service 512. This service involves requesting data from the customer relationship management system. The kind of data that can be requested includes, but is not limited to, data about the structure of the CRM database, such as abstract object types and abstract object fields, and data stored in the CRM database about specific entities (such as customers, prospects, etc.), which includes values stored in object fields of specific object instances. Among other things, this service implements sending a request to the CRM system, with a reference to a CRM object, to which the CRM system responds by providing a list of the fields available for that CRM object.

The third service is updating service 514. This service involves sending requests to the CRM system to update the data stored for a specific object. Among other things, this service implements sending a request to the CRM system, with a reference to a CRM object, field and value, to which the CRM system responds by indicating whether an update operation on that field of the CRM object to the specified value was successful or returned an error.

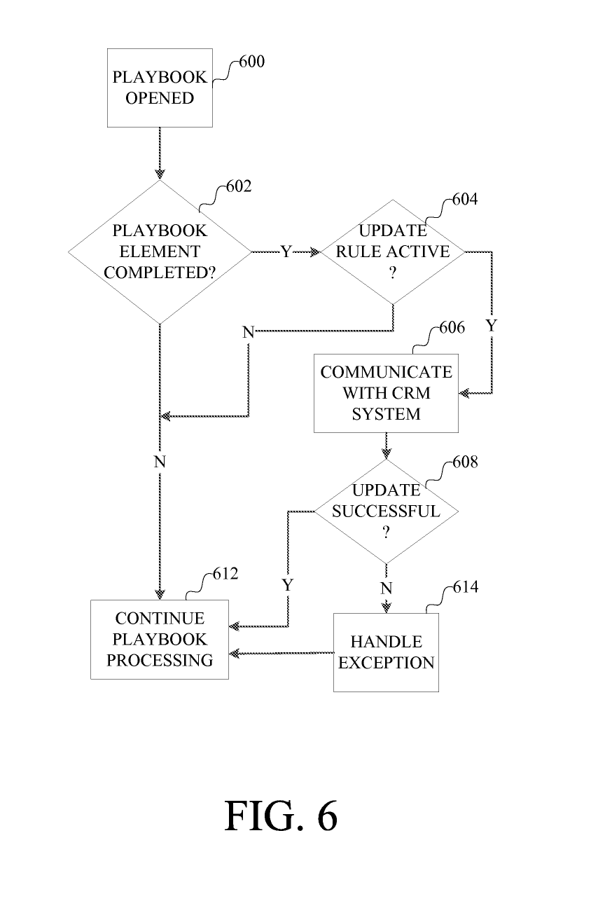

The FIG. 6 is a flowchart describing an example implementation of a process for updating the customer relationship management system.

A playbook is opened 600, with respect to a CRM object such as a prospect. If a playbook element is marked as completed, as determined at 602, then any update rule is processed. If the playbook element does not have an update rule (or if updates are disabled), as determined at 604, then the playbook system returns to its normal processing. If an update rule exists, the playbook system then communicates 606 with the CRM system to update the CRM field(s) according to the update rule. If the CRM system responds that the update was successful, as determined at 608, then the update is complete, and normal processing by the playbook system continues, as indicated at 612. If the CRM system responds that the update was not successful, then the user is notified that an error occurred, and the error is logged in the system, as indicated at 614.

The content of the sales playbook can change due to the changed data in the customer relationship management system. Thus, activity in the sales playbook can dynamically drive further actions in the sales playbook.

Having now described an example implementation of a computerized sales playbook system that updates a customer relationship management system, a computing environment for supporting such a system will now be described. Such a computing environment can include numerous general purpose or special purpose computing hardware configurations. Examples of well known computing devices, which can be microprocessor-based systems or multiprocessor systems for example, include, but are not limited to, personal computers, server computers, hand-held computing devices (for example, media players, cellular phones, personal data assistants, voice recorders), laptop computers, notebook computers, set top boxes, game consoles, programmable consumer electronics, network computers, minicomputers, mainframe computers, distributed computing environments that include any of the above devices, and the like.

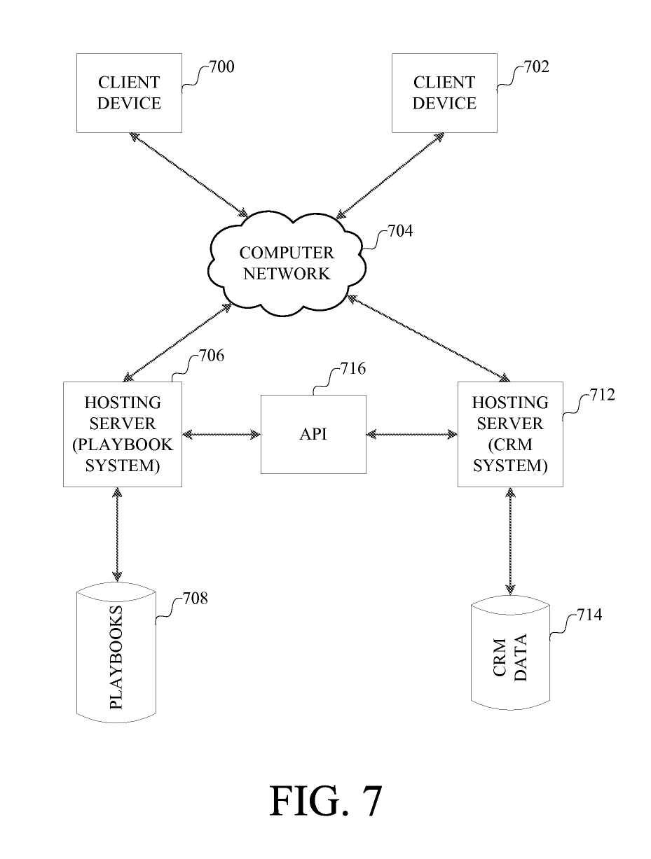

FIG. 7 illustrates an example of a networked computing system environment for implementing this sales playbook system. This is only one example of such an implementation. Other implementations are possible. The sales playbook system also can be implemented using computing environments that are not distributed, such as a single computing machine.

In FIG. 7, client devices 700 and 702 connect to a computer network 704, such as the internet. A client device can be, for example, a typical personal computer, laptop computer, notebook computer, tablet device, mobile phone or smartphone, with a variety of possible input devices and output devices.

A hosting server 706 for the computerized playbook system is connected to the computer network 704. The hosting server accesses a database 708 that stores playbook data, including playbooks and rules, including selection rules and update rules. A user accesses the hosting server through a host application (not shown), such as an internet browser, running on the client device. After logging in by providing appropriate credentials, a user is provided various interfaces by the hosting server for accessing the sales playbook system, such as the interfaces described above.

Similarly, a hosting server 712 for a customer relationship management (CRM) system is connected to the computer network 704. This hosting server accesses a database 714 that stores CRM data. A user also accesses this hosting server through a host application (not shown), such as an internet browser, running on the client device. An application programming interface (API) 716 can connect the hosting server for playbook system to the hosting server for the CRM system. This API can be used (as described above) to allow the playbook system to access CRM data for use in the sales playbook system, such as for creating content, defining rules and the like.

An example computing machine that can be used in such a networked environment to implement all or part of this sales playbook system will now be described. A computing machine typically includes at least one processing unit and memory. The computing machine may include multiple processing units and/or additional co-processing units, such as a graphics processing unit (GPU). Memory may be volatile (such as RAM), non-volatile (such as ROM, flash memory, etc.) or some combination of the two. A computing machine may include persistent storage, which can be removable or non-removable, example of which include, but are not limited to, magnetic or optical disks or tape.

Computer storage media includes volatile and nonvolatile, removable and non-removable media implemented in any method or technology for storage of information, such as computer program instructions, data structures, program modules or other data. Memory removable storage and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by a computing machine. Any such computer storage media may be part of the computing machine.

A computing machine also may have communications connection(s) that allow the computing machine to communicate with other devices over communication media. Communication media typically transmits computer program instructions, data structures, program modules or other data between storage in one device to storage in another device. By way of example, and not limitation, communication media includes wired media such as a wired network or direct-wired connection, and wireless media such as acoustic, RF, infrared and other wireless media.

A computing machine also has one or more input devices. Example input devices include but are not limited to, a keyboard, mouse, a touch input device, camera, and so on. A computing machine also has one or more output devices. Example output devices include, but are not limited to, a display, speakers, a printer, and so on. Such devices are well known in the art and are therefore not discussed at length here.

The sales playbook system is generally implemented in such an environment using computer programs, which include computer-executable instructions and/or computer-interpreted instructions, such as program modules, being processed by a computing machine. Generally, program modules include routines, programs, objects, components, data structures, and so on, that, when processed by a processing unit, instruct the processing unit to manipulate data in memory to implement data structures, or to process data into another form or representation according to defined operations. Such instructions generally are stored in and read from computer readable storage media by a processing unit.

It should be understood that the subject matter defined in the appended claims is not limited to the specific implementations described above. The specific implementations described above are presented as examples only.

What is claimed is:

1. A computerized sales playbook system comprising:
computer readable storage in which one or more sales playbooks are stored, a sales playbook comprising a plurality of playbook elements, wherein one or more of the playbook elements has an associated update rule indicating data in a customer relationship management system to be updated when the playbook element is completed;
a playbook execution engine having an input for receiving a sales playbook from the computer readable storage and having an output that presents playbook elements from the sales playbook to a user, the playbook execution engine being configured to receive input indicative of a playbook element being completed;
wherein the playbook execution engine is configured to instruct the customer relationship management system, in response to the playbook element being completed, to update the data in the customer relationship management system in accordance with the update rule associated with the completed playbook element.

2. The computerized sales playbook system of claim 1, wherein the playbook execution engine has an interface for communicating with the customer relationship management system, and the playbook execution engine is configured to send the update using the interface.

3. The computerized sales playbook system of claim 2, wherein the interface sends a command to the customer relationship management system including one or more fields to be updated and a value for each update.

4. The computerized sales playbook system of claim 3, wherein at least one of the fields to be updated is present in a display rule associated with a playbook element in a playbook, the display rule determining when to present the playbook element to the user.

5. The computerized sales playbook system of claim 1, wherein the customer relationship management system has an application programming interface allowing the playbook execution engine to request information from the customer relationship management system describing available fields.

6. A computer program product comprising:
computer readable storage;
computer program instructions stored on the computer readable storage that, when read from the storage and processed by a computer, instruct the computer to be configured as a computerized sales playbook system, comprising:
a sales playbook access module for accessing computer storage in which one or more sales playbooks are stored, a sales playbook comprising a plurality of playbook elements, wherein one or more of the playbook elements has an associated update rule;
a playbook execution engine having an input for receiving a sales playbook from the computer readable storage and having an output that presents playbook elements from the sales playbook to a user, the playbook execution engine being configured to receive input indicative of a playbook element being completed; and
wherein the playbook execution engine is configured to send an update to a customer relationship management system, in response to the playbook element being completed, in accordance with the update rule associated with the completed playbook element.

7. The computer program product of claim 6, wherein the playbook execution engine has an interface for communicating with the customer relationship management system, and the playbook execution engine is configured to send the update using the interface.

8. The computer program product of claim 7, wherein the interface sends a command to the customer relationship management system including one or more fields to be updated and a value for each update.

9. The computer program product of claim 8, wherein at least one of the fields to be updated is present in a display rule associated with a playbook element in a playbook, the display rule determining when to present the playbook element to the user.

10. The computer program product of claim 6, wherein the customer relationship management system has an application programming interface allowing the playbook execution engine to request information from the customer relationship management system describing available fields.

11. The computerized sales playbook system of claim 1, further comprising:
playbook manager providing an interface for a user to associate an update rule with a playbook element in a sales playbook.

12. The computerized sales playbook system of claim 11, wherein the customer relationship management system has an application programming interface allowing the playbook manager to request information from the customer relationship management system describing available fields for storing data in the customer relationship management system.

13. The computerized sales playbook system of claim 12, wherein the playbook manager provides an interface for the user to select from among the available fields of the customer relationship management system for use in the update rule.

14. The computer program product of claim 6, further comprising:
playbook manager providing an interface for a user to associate an update rule with a playbook element in a sales playbook.

15. The computer program product of claim 14, wherein the customer relationship management system has an application programming interface allowing the playbook manager to request information from the customer relationship management system describing available fields for storing data in the customer relationship management system.

16. The computer program product of claim 15, wherein the playbook manager provides an interface for the user to select from among the available fields of the customer relationship management system for use in the update rule.

17. A computer implemented process comprising:
accessing, using a playbook execution engine, computer readable storage in which one or more sales playbooks are stored, a sales playbook comprising a plurality of playbook elements, wherein one or more of the playbook elements has an associated update rule indicating data in a customer relationship management system to be updated when the playbook element is completed;
the playbook execution engine receiving a sales playbook from the computer readable storage;
the playbook execution engine displaying playbook elements from the sales playbook to a user;
the playbook execution engine receiving input indicative a playbook element being completed;
the playbook execution engine instructing a customer relationship management system, in response to the playbook element being completed, to update the data in the customer relationship management system in accordance with the update rule associated with the completed playbook element.

18. The computer implemented process of claim 17, wherein the playbook execution engine has an interface for communicating with the customer relationship management system, wherein the playbook execution engine instructs the customer relationship management system by sending an update using the interface.

19. The computer implemented process of claim 18, wherein the update send to the customer relationship management system includes one or more fields to be updated and a value for each update.

20. The computer implemented process of claim 19, wherein at least one of the fields to be updated is present in a display rule associated with a playbook element in a playbook, the display rule determining when to present the playbook element to the user.
